(19) United States
(12) Patent Application Publication
(10) Pub. No.: US 2024/0228201 A9
(43) Pub. Date: Jul. 11, 2024

(54) DISPERSER, DRYER, AND STORAGE BIN

(71) Applicant: HOKUTO KOHAN ENGINEERING Co., Ltd., Sapporo-shi (JP)

(72) Inventor: Masashi Hasegawa, Sapporo-shi (JP)

(73) Assignee: HOKUTO KOHAN ENGINEERING Co., Ltd., Sapporo-shi (JP)

(21) Appl. No.: 18/381,349

(22) Filed: Oct. 18, 2023

(30) Foreign Application Priority Data
Oct. 21, 2022 (JP) 2022-168858

(51) Int. Cl. B65G 69/04; B65G 3/04; F26B 25/00

(52) U.S. Cl. CPC B65G 69/0458; B65G 3/04; F26B 25/002; F26B 17/126

(57) ABSTRACT

A disperser including: a main body; a rotating shaft disposed in the main body; a dispersion plate provided on the rotating shaft and disposed in a flow path of an object to be treated that is to be charged into the main body; and a receiving blade body including a plurality of receiving blades provided on the rotating shaft at an angle formed with a vertical direction, the angle being a first angle, the receiving blade body being disposed on an upstream side of the dispersion plate in the flow path, in which the receiving blade body receives horizontal directional force from the object to be treated that flows down, and rotates the dispersion plate via the rotating shaft, and the disperser is not mounted with a power source for rotating the dispersion plate.

### BACKGROUND OF THE INVENTION

### 1. Technical Field

The present disclosure relates to a disperser, a dryer, and a storage bin.

### 2. Description of the Related Art

Conventionally, a disperser has been used for the purpose of depositing and storing an object to be treated that flows down into a storage unit such as a tank as evenly as possible in the storage unit.

For example, JP 2003-90683 A discloses a disperser provided for a grain dryer in order to disperse grain that flows down into a storage tank.

In these conventional dispersers, a rotatable dispersion plate is provided in a flow path of the object to be treated. The dispersion plate receives the object to be treated while rotating, thereby controlling a direction in which the object to be treated flows down and dispersing an amount of the object to be treated flowing into the storage unit. A power source such as an electric motor is used to rotate the dispersion plate.

### SUMMARY OF THE INVENTION

A disperser and devices such as a grain dryer and a storage bin provided with the disperser are required to suppress the running costs of the disperser and the devices.

In this respect, since conventional dispersers use a power source to rotate the dispersion plate, corresponding power consumption cannot be avoided. The power consumption and the like of the power source result in costs, which causes an increase in the running costs.

The present disclosure has been made in view of such a point, and an object thereof is to provide a disperser, a dryer, and a storage bin capable of suppressing running costs.

As a unit for solving the above-described problem, a first aspect of invention is a disperser including: a main body; a rotating shaft disposed in the main body; a dispersion plate provided on the rotating shaft and disposed in a flow path of an object to be treated that is to be charged into the main body; and a receiving blade body including a plurality of receiving blades provided on the rotating shaft at an angle formed with a vertical direction, the angle being a first angle, the receiving blade body being disposed on an upstream side of the dispersion plate in the flow path, in which the receiving blade body receives horizontal directional force from the object to be treated that flows down, and rotates the dispersion plate via the rotating shaft, and the disperser is not mounted with a power source for rotating the dispersion plate.

### BRIEF DESCRIPTION OF THE DRAWINGS

FIG. 1 is a schematic cross-sectional view of a grain dryer according to a first embodiment;

FIG. 2 is a cross-sectional view of a disperser;

FIG. 3 is a plan view of a dispersion plate:

FIG. 4 is a front view of the dispersion plate and a receiving blade body;

FIG. 5 is a plan view of the dispersion plate and the receiving blade body;

FIG. 6 is a front view of the receiving blade body and the dispersion plate with the number of the receiving blades being one:

FIG. 7 is a plan view of the receiving blade body and the dispersion plate with the number of receiving blades being one;

FIG. 8 is a schematic cross-sectional view of a storage bin according to a second embodiment:

FIG. 9 is a plan view of the receiving blade body and the dispersion plate with the number of receiving blades being four; and

FIG. 10 is a plan view of the receiving blade body and the dispersion plate with the number of the receiving blades being six.

### DETAILED DESCRIPTION

Hereinafter, embodiments of the present technology will be described with reference to the drawings. Note that the description will be given in the following order.

<1. First Embodiment>

<2. Second Embodiment>

<3. Modifications>

### 1. First Embodiment

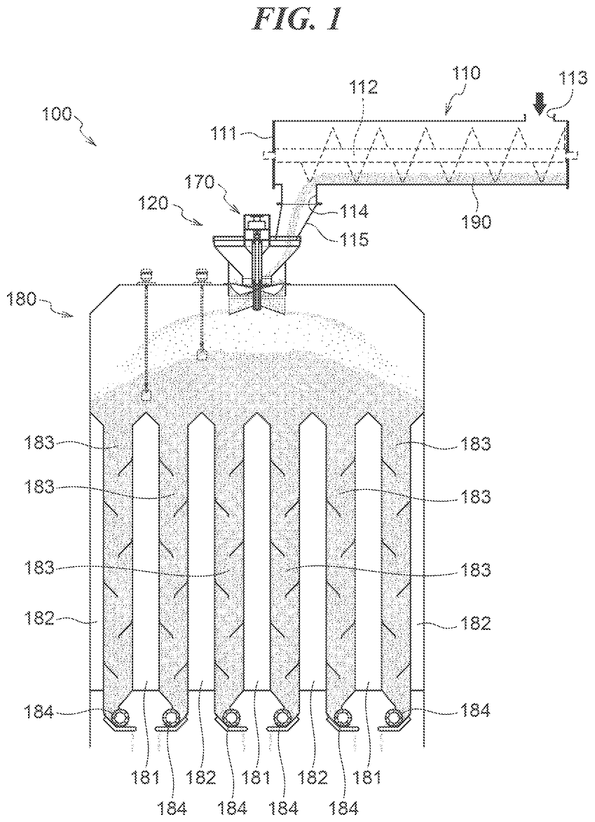

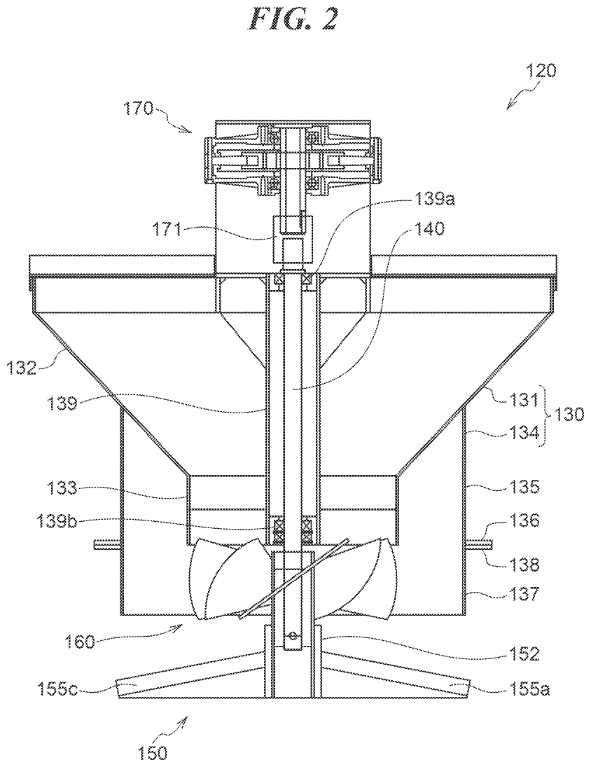

A disperser 120 and a grain dryer 100 according to the present disclosure will be described with reference to FIGS. 1 to 7.

In this embodiment, description will be given using, as an example, a case where an apparatus in which the disperser 120 is installed is the grain dryer 100.

The grain dryer 100 includes a screw conveyor 110, the disperser 120, and a dryer main body 180 in this order from an upstream side of a flow path of grain 190. First, the screw conveyor 110 will be described.

(Screw Conveyor 110)

The screw conveyor 110 is installed to convey grain 190 before drying to a downstream side toward the dryer main body 180.

A main body 111 of the screw conveyor 110 has a hollow structure. A screw 112 is horizontally bridged in a rotatable state inside the main body 111.

In addition, a charge port 113 and a discharge port 114 are opened on the upper surface and the lower surface of the main body 111, respectively. Furthermore, a screw conveyor hopper 115 is provided at the lower end of the discharge port 114.

The screw 112 is rotated, whereby the screw conveyor 110 conveys the grain 190 before drying, which has been charged from the charge port 113, to the downstream side.

Next, the disperser 120 and the dryer main body 180 will be described. The disperser 120 and the dryer main body 180 are provided in this order below the screw conveyor 110 along the flow path of the grain 190 that is an object to be treated.

(Disperser 120)

The disperser 120 is used to charge the grain 190 flowing down from the screw conveyor 110 into the dryer main body 180 as evenly as possible to prevent uneven drying.

The disperser 120 is provided on the upper surface of the dryer main body 180 and is disposed at the lower part of the screw conveyor hopper 115 so that the disperser 120 is positioned in the flow path of the grain 190 that is the object to be treated.

The disperser 120 receives the grain 190 flowing down from the screw conveyor hopper 115 once, then forcibly disperses the grain 190 by inertial force (centrifugal force) accompanying a rotational movement, and charges the grain into the dryer main body 180 as evenly as possible.

Details of the disperser 120 will be described later.

(Dryer Main Body 180)

The dryer main body 180 is for storing therein the grain 190 that has flowed down and dries the grain 190.

The dryer main body 180 includes a hollow tank body with a volume sufficient to store the grain 190. As described above, the disperser 120 is provided over the dryer main body 180, and the grain 190 that has flowed down is evenly deposited in the dryer main body 180.

A plurality of hot air paths 181 and a plurality of exhaust air paths 182 extending in an up-down direction are alternately and separately provided inside the dryer main body 180. A gap between the hot air path 181 and the exhaust air path 182 functions as a flow path (drying flow path 183) of the grain 190.

In other words, a discharge rotary valve 184 is provided at the downstream end of each drying flow path 183, and the grain 190 charged into the dryer main body 180 is urged to flow down by the discharge rotary valve 184. When passing through the drying flow paths 183, the grain 190 that flows down is deprived of moisture by the action of hot air in the hot air paths 181 and dried.

(Drying Step by Grain Dryer 100)

Next, a drying step by the grain dryer 100 will be described. The drying step by the grain dryer 100 is started by charging the grain 190 that is the object to be treated into the charge port 113 of the screw conveyor 110 installed on the upstream side of the flow path.

The charged grain 190 is conveyed to the discharge port 114 by the screw conveyor 110, and is charged into the disperser 120 via the screw conveyor hopper 115.

The disperser 120 charges the grain 190 into the dryer main body 180 as evenly as possible. The charged grain 190 is deprived of moisture by passing through the drying flow path 183 of the dryer main body 180, and is discharged in a dried state from the drying flow path 183. The above is the drying step by the grain dryer 100.

However, the grain dryer 100 may have a circulation type configuration, and the drying may be repeated by cycling the above-described drying step until the grain 190 has a predetermined moisture amount.

Note that the grain 190 may be any one or more of rice, wheat, barley, rye, oat, barnyard millet, foxtail millet, corn, soybean, red bean, buckwheat, quinoa, and grain amaranthus. In addition, other kinds of grain may be used, and the grain 190 is not limited to these kinds of grams.

(Detailed Description of Disperser 120)

Here, a configuration of the disperser 120 will be described in detail.

The disperser 120 includes a disperser main body 130, a rotating shaft 140, a dispersion plate 150, a receiving blade body 160, and a generator 170.

(Disperser Main Body 130)

The disperser main body 130 includes a hopper portion 131 located at the upper part of the disperser main body 130, a cover portion 134 located at the lower part of the disperser main body 130, and an inner cylindrical portion 139 disposed inside the hopper portion 131. The hopper portion 131 is a member having a funnel-shape as a whole and including an inverted conical trapezoidal charge port portion 132 whose diameter decreases toward the downstream side and a cylindrical discharge port portion 133 extending from the downstream end of the charge port portion 132 toward the downstream side (lower side in a vertical direction).

The cover portion 134 is a substantially cylindrical member including an upstream portion 135 and a downstream portion 137. Flange portions 136 and 138 are provided on the downstream end side of the upstream portion 135 and the upstream end side of the downstream portion 137, respectively, and both the upstream portion 135 and the downstream portion 137 are integrated as the cover portion 134 by screwing the flange portions 136 and 138.

The inner cylindrical portion 139 is for preventing the rotating shaft 140 from coming into contact with the grain 190.

The inner cylindrical portion 139 is an elongated cylindrical member and has the same length as the length of the hopper portion 131 in the vertical direction. The inner cylindrical portion 139 is disposed coaxially with the hopper portion 131 inside the hopper portion 131 by using spokes.

The rotating shaft 140 is inserted into the inner cylindrical portion 139. At this time, bearings 139a and 139b are provided at both upper and lower ends of the inner cylindrical portion 139 and support the rotating shaft 140 when the rotating shaft 140 rotates as will be described later.

Note that also when the disperser 120 is installed at the dryer main body 180, both the flange portions 136 and 138 of the cover portion 134 of the disperser main body 130 are used. In other words, since an opening serving as a flow path of the grain 190 is provided on the upper surface of the dryer main body 180, the cover portion 134 of the disperser main body 130 is first disposed coaxially with the opening. At this time, the flange portions 136 and 138 are fastened with bolts while the upper surface of the dryer main body 180 is sandwiched between the upstream portion 135 and the downstream portion 137 of the cover portion 134. As a result, the cover portion 134 of the disperser main body 130 is positioned and fixed with respect to the dryer main body 180.

Next, the hopper portion 131 of the disperser main body 130 is placed on the upper end of the positioned cover portion 134. Specifically, the upper end of the cover portion 134 comes into contact with and supports an intermediate position in the height direction of the charge port portion 132 of the hopper portion 131. Therefore, in this state, by fixing the hopper portion 131 and the cover portion 134, the disperser main body 130 and the disperser 120 are installed at the dryer main body 180.

(Rotating Shaft 140)

The rotating shaft 140 is an elongated shaft-shaped member installed inside the disperser main body 130. As will be described later, the rotating shaft 140 is connected to the dispersion plate 150 and the receiving blade body 160 to rotate the dispersion plate 150 and the receiving blade body 160 integrally.

The rotating shaft 140 is rotatably supported coaxially with the center of the disperser main body 130 via the bearings 139a and 139b inside the disperser main body 130 (the inner cylindrical portion 139 of the disperser main body 130). Since the rotating shaft 140 is set to be longer than the disperser main body 130 in the vertical direction, the upper and lower ends of the rotating shaft 140 slightly protrude from the upper and lower ends of the disperser main body 130 when the rotating shaft 140 is installed in the disperser main body 130.

(Dispersion Plate 150)

The dispersion plate 150 of an umbrella shape is provided at the lower end of the rotating shaft 140. The dispersion plate 150 is used to receive and forcibly disperse the grain 190 that has flowed down and charge the grain 190 into the dryer main body 180 as evenly as possible.

The whole of the dispersion plate 150 includes four dispersion chute portions 151a to 151d. In other words, the dispersion plate 150 has a region divided into four equal parts by diameters perpendicular to each other around a hub 152 located at the center in plan view, and the region is divided into fan-shaped first to fourth quadrants 154a to 154d. Boundary plates 155a to 155d erected in a perpendicular direction are provided on the respective boundary lines of the first to fourth quadrants 154a to 154d, and the above-described four dispersion chute portions 151a to 151d are defined, respectively, by the boundary plates 155a to 155d and the corresponding first to fourth quadrants 154a to 154d.

In addition, out of the four dispersion chute portions 151a to 151d, the dispersion chute portions 151b and 151d facing each other are provided, respectively, with falling holes 153b and 153d penetrating in the vertical direction. The falling holes 153b and 153d function to deposit the grain 190 immediately under the dispersion plate 150 as will be described later.

Note that the dispersion plate 150 is not limited to the above configuration. The configuration can be changed to another configuration as appropriate as long as the other configuration has a function of receiving and dispersing the grain 190. In the present embodiment, the integrated dispersion plate 150 is divided into the four dispersion chute portions 151a to 151d by the boundary plates 155a to 155d to divide the flow path of the grain 190 into four. However, for example, a plurality of dispersion chute portions may be separately disposed to divide the flow path.

(Receiving Blade Body 160)

The receiving blade body 160 is provided on the lower end side of the rotating shaft 140. The receiving blade body 160 is attached at a position between the downstream portion 137 of the cover portion 134 of the disperser main body 130 and the dispersion plate 150 in the flow path of the grain 190. The receiving blade body 160 rotates itself by utilizing the force of the grain 190 that has flowed down, thereby rotating the dispersion plate 150 via the rotating shaft 140.

The receiving blade body 160 includes eight receiving blades 161 as a whole. As illustrated in FIGS. 4 to 7, the receiving blade 161 is a substantially fan-shaped plate-like member, and a surface (upper surface) facing upward in the vertical direction is formed to be substantially flat. The receiving blade 161 includes, for example, stainless steel, high tensile strength steel, or the like.

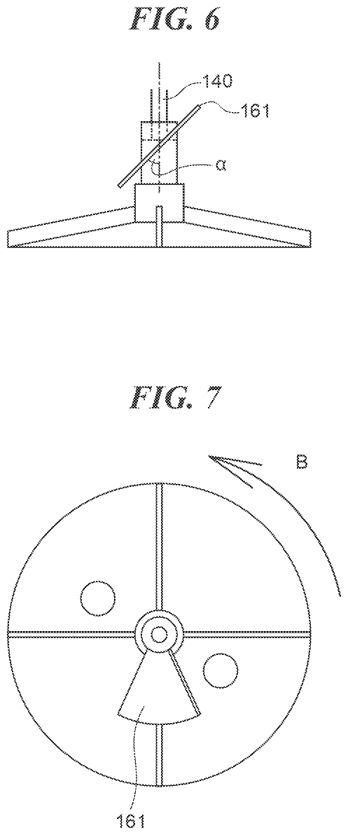

An end portion of the receiving blade 161 on the central angle side of the receiving blade 161 is fixed to the rotating shaft 140. At this time, the receiving blade 161 is attached in a state in which an angle (first angle α) formed with the vertical direction is 45 degrees (FIG. 6).

In addition, the respective receiving blades 161 are spaced apart at equal intervals in the circumferential direction of the rotating shaft 140 (FIGS. 4 and 5). The adjacent receiving blades 161 are disposed so that the adjacent receiving blades 161 partially overlap each other in a height direction in side view (the upper end edge side of a given receiving blade 161 and the lower end edge side of the adjacent receiving blade 161 are positioned on the same line in the vertical direction).

(Generator 170)

The generator 170 is provided at the upper end of the rotating shaft 140 via a coupling 171. The generator 170 converts the rotation of the rotating shaft 140 into electricity to generate power.

The configuration of the disperser 120 is as described above. Next, the movement of the grain 190 that flows down the disperser 120 and the operation of the disperser 120 will be described.

(Movement of Grain 190 that Flows Down Disperser 120)

The grain 190 discharged from the discharge port 114 of the screw conveyor 110 flows into the disperser 120. The grain 190 passes through the hopper portion 131 of the disperser main body 130 and flows down onto the receiving blade body 160 installed under the hopper portion 131.

The grain 190 that has fallen onto the receiving blade 161 flows down along the upper surface (surface on an upper side in the vertical direction) of the receiving blade 161 and further falls onto the dispersion plate 150 disposed under the receiving blade 161. The grain 190 slides along the dispersion chute portion 151 of the rotating dispersion plate 150, is dispersed in a circumferential direction and flows down so as to be even in the dryer main body 180.

In addition, since the dispersion chute portions 151b and 151d are provided, respectively, with the falling holes 153b and 153d, the grain 190 falls into the dryer main body 180 also through the falling holes 153b and 153d, and the grain 190 is evenly deposited immediately below the disperser 120 as well.

(Operation of Disperser 120)

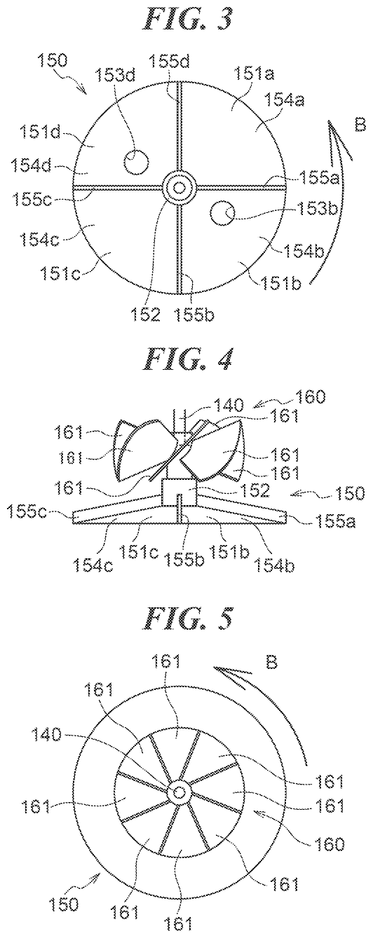

As described above, the respective receiving blades 161 of the receiving blade body 160 receive the grain 190 in the middle of the flow path once. At this time, the receiving blade 161 rotates about the rotating shaft 140 by receiving horizontal directional force due to the weight of the grain 190 and the force of the flow. This rotational movement causes the dispersion plate 150 to rotate together via the rotating shaft 140 (the rotation direction of the dispersion plate 150 is the counterclockwise direction of an arrow B in FIG. 3).

In other words, in the disperser 120 according to the present embodiment, the dispersion plate 150 can be rotated using a fall of the flow of the grain 190. A power source such as a motor is not used for the rotation. Therefore, power consumption can be suppressed and a running cost can be suppressed as compared with a conventional disperser or a grain dryer that rotates a dispersion plate using a power source.

Furthermore, since the disperser 120 according to the present embodiment has a motor-less structure, maintainability is excellent. In addition, the disperser 120 according to the present embodiment has an advantage that the weight of the entire disperser 120 can be reduced because no power source is installed. Note that although the disperser 120 according to the present embodiment has a motor-less structure, it is not excluded that a power source such as a motor is used in combination as a unit for rotating the dispersion plate 150.

Furthermore, the upper surface of the receiving blade 161 is formed to be substantially flat. For example, in a case where the upper surface is in a round shape, force received from the grain 190 is dispersed. However, since a substantially flat configuration is adopted, the force from the grain 190 can be received directly, and the receiving blade body 160 and also the dispersion plate 150 can be more efficiently rotated.

Furthermore, since the generator 170 is connected to the rotating shaft 140, power can be generated at the same time as when the dispersion plate 150 rotates.

Note that the configuration of the grain dryer 100 is not limited to the configuration in the present embodiment. The present disclosure can be applied to a grain dryer as long as in terms of configuration, the grain dryer includes, in the upper part thereof, a grain conveyance unit and in the lower part thereof, a grain drying unit, and the grain dryer is configured to dry, in the grain drying unit, grain that has flowed down from the grain conveyance unit. The grain conveyance unit (corresponds to the screw conveyor 110) is configured to convey grain. The grain drying unit (corresponds to the dryer main body 180) is configured to dry the grain that flows down.

Furthermore, in the present embodiment, description has been given using the dryer of a hot-air type, but the present disclosure is not limited to this drying type. For example, the present disclosure can also be applied to a dryer of a far infrared ray type.

### 2. Second Embodiment

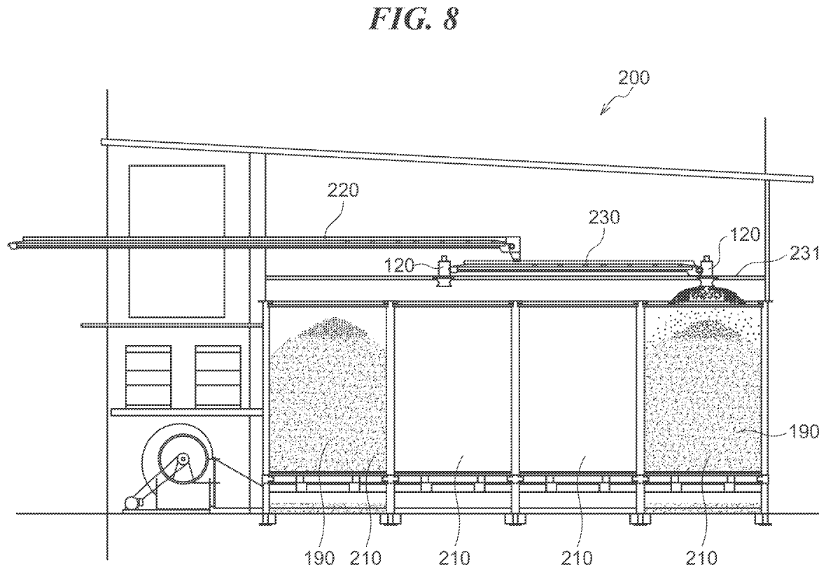

A disperser 120 and a storage bin 200 according to the present disclosure will be described with reference to FIG. 8.

In this embodiment, description will be given using, as an example, a case where an apparatus in which the disperser 120 is installed is the storage bin 200. The same members as those of the first embodiment are denoted by the same reference signs, and the detailed description thereof will be omitted.

The storage bin 200 is used to temporarily store, for example, the undried grain 190. The storage bin 200 includes storage bin main bodies 210, a belt conveyor for charging grain into a bin 220, a moving belt conveyor 230, and a disperser 120.

The storage bin main body 210 is a hollow storage tank in which the grain 190 can be stored.

The belt conveyor for charging grain into a bin 220 is provided over the storage bin main body 210 and is configured to convey the grain 190. Furthermore, the moving belt conveyor 230 is installed below the belt conveyor for charging grain into a bin 220 so that the moving belt conveyor 230 is movable in a horizontal direction along a guide rail 231.

The dispersers 120 are provided at both ends of the moving belt conveyor 230 in the horizontal direction. A configuration of the disperser 120 is the same as the configuration in the first embodiment.

The grain 190 is first conveyed in the horizontal direction by the belt conveyor for charging grain into a bin 220 and thrown down to the moving belt conveyor 230. Next, the grain 190 is further conveyed in the horizontal direction by the moving belt conveyor 230, passes through the disperser 120 provided at the end, is dispersed as evenly as possible, charged into the storage bin main body 210, and deposited.

In the present embodiment, a plurality of storage bin main bodies 210 is provided side by side. The grain 190 can be charged into a desired storage bin main body 210 by moving the moving belt conveyor 230 in the horizontal direction and rotating the belt conveyor in normal and reverse directions to control a charging position.

As described above, since the configuration of the disperser 120 is the same as the configuration in the first embodiment, the dispersion plate 150 can be rotated using a fall of the flow of the grain 190 without using a power source in the storage bin 200. Therefore, power consumption can be suppressed, and a running cost can be suppressed as compared with a storage bin provided with a disperser using a power source such as a motor.

In addition, a generator 170 connected to a rotating shaft 140 can simultaneously generate power.

Note that a configuration of the storage bin 200 is not limited to the configuration in the present embodiment. The present disclosure can be applied to a grain storage bin as long as in terms of configuration, the grain storage bin includes, in the upper part thereof, a grain conveyance unit and in the lower part thereof, a grain storage unit, and the grain storage bin is configured to store, in the grain storage unit, the grain that has flowed down from the gram conveyance unit. The grain conveyance unit (corresponds to the belt conveyor for charging grain into a bin 220 and/or the moving belt conveyor 230) is configured to convey grain. The grain storage section (corresponds to the storage bin main body 210) is configured to store the grain that flows down.

### 3. Modifications

Although the embodiments of the present disclosure have been described in detail above, the present disclosure is not limited to the above-described embodiments, and various modifications based on the technical idea of the invention can be made.

In the present embodiment, description has been given using, as an example, a case where an object to be treated is grain, but the object to be treated is not limited to grain. For example, the present disclosure can also be used when a disperser is used to disperse vegetables such as potatoes, root vegetables, bulb vegetables, pulses (seeds), legume vegetables (immature), cucurbitaceous fruits, solanaceous fruit vegetables, cruciferous vegetables (flower buds and stems), leaf vegetables, stem vegetables, and edible flowers. Furthermore, the present disclosure can also be used when a disperser is used to disperse fruits such as citrus fruits, pome fruits, stone frits, small fruits such as berries, and mushrooms. Furthermore, the present disclosure can also be used when a disperser is used to disperse pseudocereals or pseudograins. In addition, the object to be treated is not limited to foods.

In addition, in the present embodiment, the first angle α of the receiving blade 161 is set to 45 degrees, but the first angle α is not limited to 45 degrees. To efficiently convert force that the receiving blade 161 receives from the grain 190 into a rotational movement, it is desirable to set the first angle α within a range of approximately 35 degrees to approximately 50 degrees. However, this value is merely a preferred example, and it is not excluded that the first angle α is set to a degree outside the range of approximately 35 degrees to approximately 50 degrees.

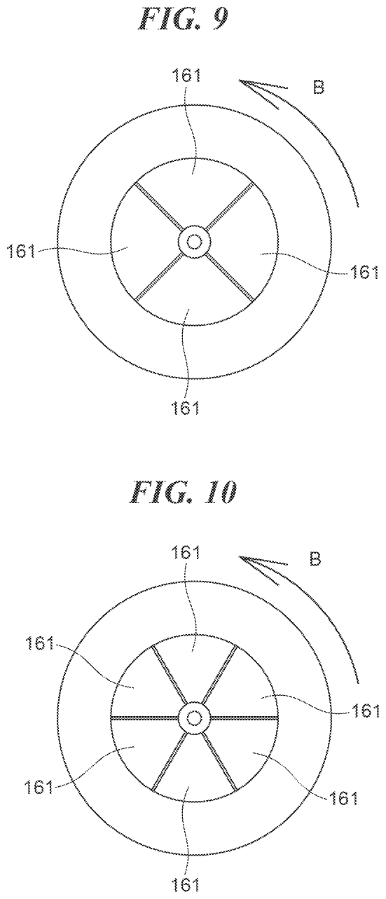

In addition, in the present embodiment, the receiving blade body 160 includes a total of eight receiving blades 161, but the number of the receiving blades 161 is not limited to eight. As illustrated in FIGS. 9 and 10, the receiving blade body 160 may include four or six receiving blades 161. However, this value is merely a preferred example, and it is not excluded that the receiving blade body 160 includes the receiving blades 161, the number of which is any value other than four and six.

The present disclosure makes it possible to provide a disperser, a dryer, and a storage bin capable of suppressing running costs.

This application claims the benefit of Japanese Patent Application No. 2022-168858, filed Oct. 21, 2022, which is hereby incorporated by reference herein in its entirety.

1. A disperser comprising:
a main body;
a rotating shaft disposed in the main body;
a dispersion plate provided on the rotating shaft, the dispersion plate being disposed in a flow path of an object to be treated that is to be charged into the main body; and
a receiving blade body including a plurality of receiving blades provided on the rotating shaft at an angle formed with a vertical direction, the angle being a first angle, the receiving blade body being disposed on an upstream side of the dispersion plate in the flow path, wherein
the receiving blade body receives horizontal directional force from the object to be treated that flows down, and rotates the dispersion plate via the rotating shaft, and
the disperser is not mounted with a power source for rotating the dispersion plate.

2. The disperser according to claim 1, wherein
the first angle is between approximately 35 degrees and approximately 50 degrees.

3. The disperser according to claim 1, wherein
four to eight receiving blades are provided while spaced apart from each other in a circumferential direction of the rotating shaft.

4. The disperser according to claim 1, wherein
the receiving blade has a substantially flat upper surface that receives the object to be treated.

5. The disperser according to claim 1, wherein
the object to be treated is grain.

6. The disperser according to claim 1, wherein
the object to be treated is any one or more of rice, wheat, barley, rye, oat, barnyard millet, foxtail millet, corn, soybean, red bean, buckwheat, quinoa, and grain amaranthus.

7. The disperser according to claim 1, wherein
a generator is further provided on the rotating shaft.

8. A dryer comprising the disperser according to claim 1.

9. A storage bin comprising the disperser according to claim 1.
